(19) United States
(12) Patent Application Publication
(10) Pub. No.: US 2021/0122609 A1
(43) Pub. Date: Apr. 29, 2021

(54) METHOD AND DEVICE FOR REPORTING FAULT STATES RELATING TO COMPONENTS OF A PASSENGER TRANSPORT SYSTEM IN A MACHINE-SUPPORTED MANNER AND INFORMING A MONITORING DEVICE ON REPORTED FAULT STATES IN A MACHINE-SUPPORTED MANNER

(71) Applicant: Inventio AG, Hergiswil (CH)

(72) Inventors: Daniel Meierhans, Sins (CH); Faruk Osmanbasic, Sins (CH)

(21) Appl. No.: 15/733,428

(22) PCT Filed: Mar. 26, 2019
(86) PCT No.: PCT/EP2019/057488

§ 371 Date: Jul. 27, 2020

(30) Foreign Application Priority Data
Mar. 28, 2018 (EP) 18164486.5

(51) Int. Cl. B66B 5/00; B66B 25/00; B66B 1/34

(52) U.S. Cl. CPC B66B 5/0087; B66B 1/3407; B66B 1/3461; B66B 25/006

(57) ABSTRACT

A method for reporting component fault states of a passenger transport system includes the steps: detecting identity information and/or fault state information of a component being examined using a reporting device; automatically transmitting the detected information to an analysis device; automatically selecting a selection of possible causes of the fault from a list based on the identity information and/or the fault information and transmitting corresponding selection information to the reporting device; automatically outputting the selection information from the reporting device and receiving sub-selection information describing a sub-selection selected by a reporter from the selection of possible causes of the fault; and automatically transmitting the sub-selection information to the analysis device. Possible causes of the fault states are reported and collected in a simple and standardized manner. A monitoring device is informed of possible causes of faults that arise frequently so that components can be further developed in a targeted manner.

### FIELD

The present invention pertains to a method and a device for reporting fault states relating to components of a passenger transport system in a machine-supported manner. The invention also pertains to a method and a device for informing a monitoring device on reported fault states relating to components of a passenger transport system in a machine-supported manner. The invention furthermore pertains to a corresponding computer program product, as well as to a machine-readable medium with such a computer program product stored thereon.

### BACKGROUND

Passenger transport systems such as elevators, escalators or moving walkways serve for transporting persons in buildings. These passenger transport systems have to meet strict requirements with respect to their safety and reliability. Consequently, the correct assembly in accordance with target specifications has to be ensured during the installation of a passenger transport system. It also has to be ensured that safety and reliability specifications are observed during the operation of the respective passenger transport system, e.g. by means of monitoring and maintenance measures.

EP 1 628 899 B1 describes a method and a device for maintaining an elevator or escalator system.

Passenger transport systems generally consist of a plurality of different components. For example, an elevator system may comprise, among other things, an elevator car and a counterweight that are suspended on suspension means and guided along guide rails in an elevator shaft, wherein a motion of the elevator car and the counterweight is effected by a drive unit and controlled by a control unit. Sensor components may serve for detecting prevailing conditions within the elevator system, e.g. in order to correspondingly adapt the operation of the elevator system. Safety components may be distributed over the elevator system in order to monitor its safe operation. All these different components can have malfunctions, e.g. due to wear or defects.

Consequently, it has to be ensured that all components are selected correctly, function correctly and are installed correctly during the installation of a passenger transport system. It also has to be ensured that the components used have the required properties in the course of subsequent monitoring measures, maintenance procedures and optionally during the replacement of components.

Until now, a technician who installed or maintained a passenger transport system had to independently check the components used for their compliance with the respectively required properties. If the required properties did not exist, the technician had to independently search for a solution in order to finish the installation or maintenance of the passenger transport system. To this end, the technician potentially had to arduously determine properties of a component to be used, e.g. based on operating instructions or other documentations, in order to be able to suitably modify and thereby render the component usable.

Since identically or similarly designed passenger transport systems and their components are frequently installed, it was furthermore desirable that the technician generated a report, for example, when an undesirable property or a defect of a component to be used was detected. In other words, the technician should not only have determined that a component did not function as desired and then optionally repair or replace the respective component, but also generate a report on such an incident.

Such reports were intended to enable, for example, the development division of a manufacturer of the passenger transport system to detect and largely eliminate system-related and therefore frequently occurring fault states or fault sources in the passenger transport system.

In practical applications, however, it was observed that reports on fault states are frequently not generated or not suitably generated by the respective technicians. It was furthermore determined that generated reports were frequently difficult to evaluate.

Consequently, there may be a demand for acquiring fault states relating to components of a passenger transport system more reliably and to report these fault states in such a way that useful information regarding the reported fault states in the components can be derived.

### SUMMARY

Such a demand can be met with the respective methods and devices, as well as with a computer program product and a machine-readable medium provided with said computer program product, according to advantageous embodiments in the description.

According to a first aspect of the invention, a method for reporting fault states relating to components of a passenger transport system in a machine-supported manner is proposed. The method is sometimes also referred as “reporting method” below. This method comprises at least the following steps, preferably in the cited sequence:

acquiring identity information and/or fault information by means of a reporting device, wherein the identity information describes an identity of a component being examined, and wherein the fault information describes a fault state in a component being examined;

automatically transmitting the identity information and/or the fault information to an analysis device in a first data transmission process;

automatically selecting a selection of possible causes of the fault from a list of possible causes of faults stored in the analysis device based on the identity information and/or the fault information and transmitting corresponding selection information, which describes the selection of possible causes of the fault, to the reporting device in a second data transmission process;

automatically outputting the selection information on possible causes of the fault by means of the reporting device and receiving sub-selection information, which describes a sub-selection selected by a reporter from the selection of possible causes of the fault; and

automatically transmitting the sub-selection information to the analysis device in a third data transmission process.

According to a second aspect of the invention, a method for informing a monitoring device on reported fault states relating to components of a passenger transport system in a machine-supported manner is proposed. The method is sometimes also referred to as “informing method” below. The method comprises at least the following steps, preferably in the cited sequence:

collecting possible causes of faults for reported fault states, wherein the following steps are carried out multiple times:
receiving identity information and/or fault information in an analysis device, wherein the identity information was acquired by means of a reporting device and describes an identity of a component being examined, and wherein the fault information was acquired by means of the reporting device and describes a fault state in a component being examined;
automatically selecting a selection of possible causes of the fault from a list of possible causes of the fault stored in the analysis device based on the identity information and/or the fault information and transmitting corresponding selection information, which describes the selection of possible causes of the fault, to the reporting device;
receiving sub-selection information in the analysis device, wherein the sub-selection information describes a sub-selection selected by a reporter from the selection of possible causes of the fault; and

automatically informing the monitoring device as soon as a frequency, with which a possible cause of a fault was received by the analysis device specifically for a certain component type, exceeds a predefined frequency threshold value.

According to a third aspect of the invention, a device for reporting fault states relating to components of a passenger transport system in a machine-supported manner is proposed, wherein the device is configured for carrying out or for controlling a method according to an embodiment of the first aspect of the invention. Such a device is referred to as report generating device herein.

According to a fourth aspect of the invention, a device for evaluating reported fault states relating to components of a passenger transport system in a machine-supported manner and for informing a monitoring device in a machine-supported manner is proposed, wherein the device is configured for carrying out or for controlling a method according to an embodiment of the second aspect of the invention. Such a device is referred to as evaluating device herein.

According to a fifth aspect of the invention, a computer program product comprising machine-readable instructions is proposed, wherein said instructions prompt a processor to carry out or to control a method according to the first aspect or the second aspect of the invention.

According to a sixth aspect of the invention, a machine-readable medium with a computer program product according to the fifth aspect of the invention stored thereon is proposed.

Potential characteristics and advantages of embodiments of the invention may, among other things, be considered to be based on the ideas and realizations described below without thereby restricting the invention.

As initially mentioned, detected fault states in components of a passenger transport system were until now frequently not reported or insufficiently reported. Even if a report was generated, this report in many instances did not make it possible to derive useful information from the reported fault states in order to thereby improve the component or its use in the passenger transport system in the future.

It was observed, in particular, that the task of writing a report represented a significant expenditure of time for a technician and therefore was in some instances ignored by the technician. It was furthermore determined that reports by different technicians were formulated in very different ways, even if they concerned similar or even identical deficiencies of a component. This was aggravated by the fact that passenger transport systems and their components are installed and operated under very different conditions, wherein the technicians used for their installation or maintenance may, for example, have different qualifications or speak different languages or different tools or documentations may be available to the technicians. In addition, an evaluation of the registered reports proved to be extremely difficult, for example, because information required for carrying out the evaluation in a sensible manner was sometimes not included in the report. Consequently, it was frequently almost impossible to derive information from the registered reports, which would have enabled, e.g., a manufacturer of the passenger transport system to systematically improve the passenger transport system or products or services associated therewith.

Embodiments of the proposed method and the proposed device according to the first and the third aspect of the invention should on the one hand simplify the reporting process and on the other hand make it possible to report the detected fault states in such a way that their evaluation can subsequently be carried out in a simple and targeted manner. To this end, the reporting process may be carried out by using a reporting device that is specially configured for this purpose, as well as a specially configured analysis device. In this case, the reporting process may on the one hand be carried out in a machine-supported manner by means of the reporting device and the fault states reported in the process can on the other hand be suitably analyzed by the analysis device in order to subsequently support the reporter in the reporting process.

Embodiments of the proposed method and the proposed device according to the second and fourth aspect of the invention can be used for suitably analyzing the reported fault states in order to be able to derive suitable information therefrom. To this end, for example, the analysis device can carry out the proposed method and in the process collect possible causes of a fault, which were determined to be causative for certain fault states in many reports, as well as automatically inform a monitoring device in a suitable manner, e.g. based on the frequency, with which a possible cause of a fault occurs. Developers can then enhance the faulty component based on the information available in the monitoring device in order to correct system-related fault states, e.g. with structural or functional modifications.

Potential designs and embodiments of the method according to the first aspect of the invention and the report generating device according to the third aspect of the invention are initially described below.

In order to generate a report relating to a fault state in a component of the passenger transport system, a technician can utilize functionalities made available by the reporting device and the analysis device. These functionalities are implemented in the report generating device, which may therefore comprise a reporting device and an analysis device in the form of separate devices. In this case, the reporting device and the analysis device may respectively comprise separate processors and optionally separate data memories for processing and storing data. Both devices may furthermore comprise suitable communication devices in order to be able to exchange information with one another.

As soon as a technician detects that a component of the passenger transport system is faulty and decides to generate a corresponding report, the technician can utilize the reporting device for this purpose. This reporting device is specially designed for supporting the technician in reporting the fault state in such a way that the technician can on the one hand generate the report with the least effort possible and the report is on the other hand generated in a way that subsequently simplifies a purposeful evaluation of the information contained therein.

The reporting device may be a portable device that can be carried along by the technician. The reporting device may utilize hardware that was specially developed for this purpose. The reporting device may alternatively utilize existing hardware, e.g. in the form of an intelligent portable device such as a smartphone or a notepad, wherein a functionality to be achieved can be realized by means of programming with a suitable computer program product, i.e. software.

The reporting device enables the technician to determine the identity of the faulty component being examined in a machine-supported manner on the one hand and to acquire corresponding identity information, as well as to forward this identity information in the form of a signal, on the other hand.

For example, an individual ID (identification code) may be assigned to each component installed in a passenger transport system. Components belonging to a certain component type may have the same IDs, which are optionally supplemented with a serial number or the like.

The ID of a component may be arranged on the component in the form of machine-readable information such that it can be read out by the reporting device. This enables the technician to easily determine and forward the identity of the component being examined in an automated manner. The information preferably is stored in such a way that it can be read out in a contactless or non-contacting manner.

For example, the identity information may be stored in the form of an optically readable code, e.g. in the form of a barcode or QR code, and read out with the aid of a scanner integrated into the reporting device. Such optically readable codes can on the one hand be easily and inexpensively attached to a component, e.g. in the form of an adhesive label. On the other hand, they can be easily and reliably read out with an optical scanner, e.g. in the form of a camera.

The technician can additionally or alternatively utilize the reporting device for acquiring fault information that respectively describes or correlates with a fault state of the component being examined.

For example, the technician can record an image of a faulty part of the component with a camera integrated into the reporting device. The fault information may be alternatively acquired by the technician, e.g., by inputting a short description, by selecting an associated symbol or the like.

The thusly acquired identity information and/or fault information is transmitted to the analysis device in the first data transmission process. The analysis device may be arranged remotely from the reporting device in this case. The analysis device particularly may be realized in the form of a separate computer, a server or in the form of a data cloud (cloud). The transmission of information between the reporting device and the analysis device may take place in a wire-bound or wireless manner. The transmission of information may take place via a data network such as the Internet. Information particularly can be transmitted to the analysis device by a plurality of different reporting devices such that the analysis device can over time collect information on a plurality of reported fault states and the associated possible causes of the respective faults.

The received identity information and/or the received fault information can be additionally processed within the analysis device to the effect that a selection of possible causes of a fault, which could be causative for the fault state observed in the component being examined, is selected based on this information. To this end, a list of possible causes of faults may be stored in the analysis device, e.g. in a database. The possible causes of faults, which are with a certain probability causative for the observed fault state, can be selected from this list based on the identity information and/or the fault information.

For example, a plurality of already known causes of faults may be stored in the list for each component type. If a fault state occurs in a component of this component type, all these possible causes of faults for this component type can be selected. In addition, the fault information can be used, for example, for filtering out the possible causes of faults that may be causative or are most likely assumed to be causative for a certain fault state of the type indicated by the fault information.

In addition to the list of possible causes of faults, one or more proposals for correcting the fault state associated with each possible cause of a fault may be stored in the analysis device.

In a second data transmission process, the analysis device can then transmit the determined information on the selection of possible causes of faults, which is referred to as “selection information” herein, and optionally the respectively associated proposals for correcting the fault state, i.e. the correction information, to the reporting device.

In this case, the selection information and/or the correction information preferably can be transmitted in a language that can be preset by the reporter. All possible causes of faults in the list of possible causes of faults may in this case be stored in the analysis device such that they are translated into different languages. Alternatively, translations of possible causes of faults can be generated on demand, e.g. by utilizing translation software. This applies analogously to the proposals for correcting the respective fault states. Consequently, the reporter can adjust his reporting device in such a way that the selection information and/or the correction information is displayed in a language that the reporter can understand. This reduces the risk of misunderstandings due to lacking foreign language skills of the technician.

The reporting device can automatically output the selection information and optionally also the correction information in such a way that it can be perceived by the reporting technician. For example, the selection information and/or the correction information may be displayed on a display of the reporting device in the form of text, symbols or the like.

The technician can then select the possible cause of a fault, which from his point of view is actually causative for the observed fault state, from the displayed selection information. In this case, the technician can optionally utilize the associated correction information in order to attempt to respectively repair the component being examined or to correct the fault state. In this way, the technician can determine which of the possible causes of faults proposed in the selection information is actually causative for the fault state and therefore can be corrected in accordance with the correction information in an even more reliable manner.

The technician can subsequently select a sub-selection from the selection information being output on his reporting device. Corresponding sub-selection information can then be automatically transmitted to the analysis device in the course of a third data transmission process.

Consequently, the identity information and/or the fault information, which make it possible to draw conclusions on the component being examined and possibly their current fault state, as well as the sub-selection information, which makes it possible to draw conclusions on a most probable cause of the observed fault state, are available in the analysis device after the proposed reporting method has been carried out. This information was acquired and transmitted by the technician with the aid of his reporting device in standardized form and therefore allows an evaluation of this information that can be standardized.

According to an embodiment, usage site information, which describes a usage site of the component being examined, can be additionally transmitted in the first transmission process. In other words, the reporting device not only can transmit the identity information and/or the fault information to the analysis device, but also information that describes, e.g., where the reporting device is used and therefore where the component being examined was installed.

For example, the usage site information may be permanently stored in the reporting device, e.g. if it can be assumed that a reporting device is only used in a certain region or in a certain country. The usage site information may alternatively be determined from data acquired on-site, e.g. from GPS information. In this context, the usage site information may describe the location, at which the passenger transport system is located.

During the subsequent evaluation of the identity information, fault information and sub-selection information, the usage site information also makes it possible, for example, to take into account the usage site, at which the component being examined was installed. Influences on the component, which ultimately lead to a fault state, may in many instances depend on the usage site. For example, environmental influences such as climatic conditions and stresses acting upon a component may differ from usage site to usage site. Environmental influences may lead, for example, to accelerated wear of a component. Methods for installing components in a passenger transport system may also differ from usage site to usage site. For example, technicians in certain countries may use different tools or be trained differently than in other countries.

In a special embodiment, the usage site information may also describe the usage site of the component more precisely and therefore indicate the position, at which the component being examined is located within the passenger transport system.

If the evaluation of the information shows that certain fault states and their selected possible causes occur only or predominantly at certain usage sites, this can provide a valuable reference as to how the component being examined would have to be modified in order to prevent the corresponding fault states in the future.

Potential designs and embodiments of the informing method according to the second aspect of the invention and the evaluating device according to the fourth aspect of the invention are described below.

While the above-described method for reporting fault states in a machine-supported manner typically utilizes two separate devices, namely the reporting device and the analysis device, and different steps are respectively carried out in one of the two devices, the method for informing a monitoring device on reported fault states in a machine-supported manner according to the second aspect of the invention typically is carried out in the evaluating device only. With respect to its device technology or its functionalities, the evaluating device may correspond to or comprise the above-described analysis device. The evaluating device particularly may be realized in the form of an individual technical device, e.g. an individual computer, or in the form of a network of devices, e.g. a data cloud.

In a first step of the informing method, a plurality of possible causes of reported fault states initially is collected in the course of time. In other words, the above-described reporting method can be carried out multiple times, e.g. by different reporters and with respect to different passenger transport systems, and the possible causes of faults, which are respectively indicated in the selection information transmitted to the analysis device, can be collected in the process.

The evaluating device or its analysis device respectively receives identity information and/or fault information concerning the identity or the fault state of a component being examined each time the reporting method is carried out. The analysis device then automatically selects a selection of possible causes of the fault with consideration of this identity information and/or fault information and transmits this selection to the respective reporting device, from which the respective identity information or fault information was received, in the form of selection information. The analysis device then receives the sub-selection information, which was selected by the reporter and contains information on the most likely cause of an observed fault state, from the reporting device.

However, the information on the possible causes of faults should not only be collected in the analysis device, but also serve for enabling, for example, a manufacturer of passenger transport systems to detect systematically occurring faults in components of a passenger transport system and to suitably enhance the respective component.

To this end, it would basically be possible to forward each generated report to a monitoring device that is operated, for example, by the manufacturer of the passenger transport system. However, it was observed that many fault states occurring in practical applications are not system-related, but rather occur randomly. In addition, fault states may be simply caused by the inadvertent installation of an unsuitable component in a passenger transport system. Non-selective forwarding of reports could therefore be associated with an inexpedient effort for the evaluation of the reports.

In the informing method proposed herein, the monitoring device therefore is only automatically informed when a certain cause of a fault occurs specifically for a certain component type with particularly high frequency and therefore is particularly frequently reported to the analysis device.

To this end, a frequency threshold value may be defined beforehand for each component type and each possible cause of a fault concerning this component type. In this case, the analysis device automatically informs the monitoring device as soon as a possible cause of a fault for this component type is reported more frequently than the frequency threshold value. Developers can determine that the possible cause of the fault appears to occur systematically and causes fault states in the component type in question based on the information of the monitoring device. The component type can then be suitably modified.

The frequency threshold value may be predefined with consideration of physical properties and/or functionalities of the certain component type. In other words, the structural design of a component type can influence the definition of the frequency threshold value. In addition, a functionality to be implemented with the component type may be taken into consideration in defining the frequency threshold value.

For example, if a component type is already predestined for certain wear due to its physical design and this was already taken into consideration in the conception of the passenger transport system, a corresponding frequency threshold value for associated fault states can be defined relatively high. However, if a component should implement a safety-relevant function, for example, a low frequency threshold value can be chosen for possible causes of faults that lead to fault states in this component type.

The frequency threshold value may furthermore be predefined with consideration of a frequency of use of the certain component type. In other words, the frequency, with which the component type in question is actually used in the passenger transport system, may be taken into consideration in defining the frequency threshold value. The frequency threshold value for component types that are only rarely installed may be predefined lower than for component types that are frequently installed and in which fault states therefore also statistically occur and are reported more frequently.

According to an embodiment, usage site information may be additionally received by the analysis device during the collection of possible causes of faults. This usage site information describes a usage site of the component being examined. In this case, the frequency threshold value may be predefined with consideration of the usage site of the certain component type.

In other words, the usage site may influence the frequency, with which certain fault states occur in a component type, as already mentioned above. Consequently, the information on the usage site can also be transmitted when the monitoring device is informed, for example, in order to enable a developer to draw conclusions on which typical conditions at the usage site could be causative for an observed possible cause of a fault.

Since the information on the usage site is taken into consideration in predefining the frequency threshold value, the decision of the analysis device as to whether the monitoring device is informed can be made conditional on the usage site, from which certain possible causes of faults are reported. This makes it possible to take into consideration that it may already be known that certain fault states frequently occur at certain usage sites, e.g. due to prevailing climatic conditions, and this is tolerated whereas a frequent occurrence of fault states at other usage sites could indicate a systematic design flaw of the component type.

According to an embodiment of the method proposed herein, it is furthermore possible to transmit corresponding information from the analysis device to the reporting device as soon as an option for correcting a possible cause of a fault has been found. The possible cause of a fault may have been corrected, for example, due to a technical enhancement of the component type. This information can reach the technician, who previously reported the fault state, via the reporting device.

On the one hand, this makes it possible to inform the technician that optionally enhanced components are in the meantime available and that, for example, faulty components can in the future be replaced with such enhanced components.

On the other hand, the transmission of such information can contribute to motivating the technician to report fault states. It was particularly observed that technicians, who were informed that their reports actually led to an enhancement of a faulty component, are more motivated to take on the effort of generating a report.

If applicable, the payment of a bonus may represent an additional motivation or incentive for generating a report directly or after the development of an option for correcting the reported possible cause of a fault based on the report. To this end, records on when and about what component a technician has generated a report can be kept in the evaluating device or in the analysis device and the stored data can be taken into consideration in the calculation of bonuses.

Embodiments of the reporting method and the informing method described herein can be implemented on programmable devices with the aid of a computer program product. The computer program product may be executed on one or more processors of a report generating device or an evaluating device, particularly on a processor of a reporting device and/or a processor of an analysis device. The execution of the computer program product particularly may be distributed over several components of a data cloud (cloud). The computer program product may be programmed in any computer language.

The computer program product may be stored on any machine-readable medium. For example, the computer program product may be stored on a CD, a DVD, a flash memory, etc. The computer program product may also be stored on individual computers or a network of computers and correspondingly downloaded, e.g. via the Internet.

It should be noted that a few of the potential characteristics and advantages of the invention are described herein with reference to different embodiments of the proposed methods on the one hand and with reference to the devices used for carrying out these methods on the other hand. A person skilled in the art realizes that the characteristics can be suitably combined, transferred, adapted or interchanged in order to arrive at other embodiments of the invention.

Embodiments of aspects of the invention are described below with reference to the attached drawing, wherein neither the drawing nor the description should be interpreted in a restrictive sense.

### DESCRIPTION OF THE DRAWINGS

FIG. 1 shows an arrangement of devices, by means of which the methods proposed herein can be implemented, according to an embodiment of the present invention.

The FIGURE is merely schematic and not true-to-scale. Identical or identically acting characteristics are identified by the same reference symbols.

### DETAILED DESCRIPTION

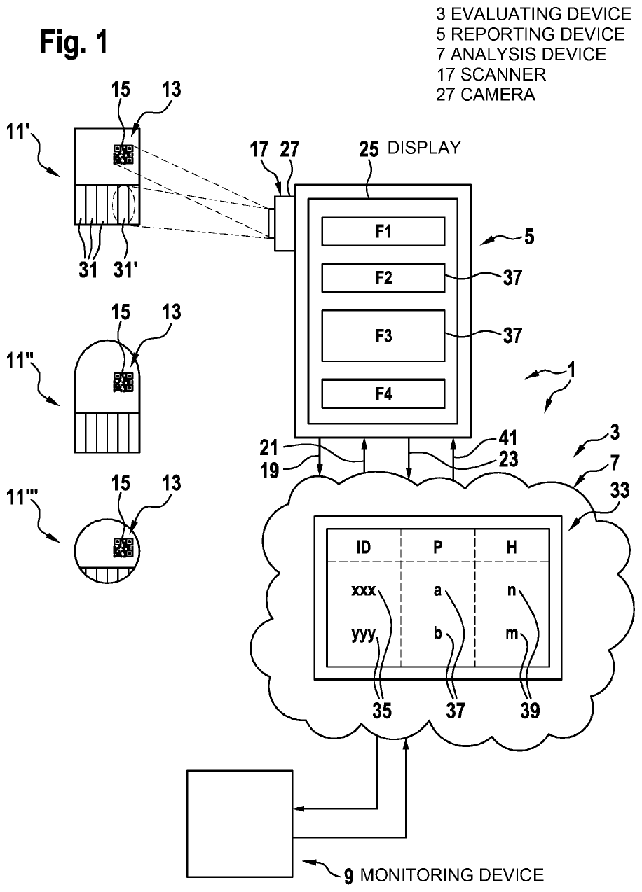

FIG. 1 shows a report generating device 1, by means of which fault states relating to different components 11′, 11″, 11′″ of a passenger transport system can be reported in a machine-supported manner in accordance with an embodiment of the present invention. The report generating device 1 comprises at least one reporting device 5 and an analysis device 7. The analysis device 7 may be simultaneously considered to be part of an evaluating device 3, by means of which reports reported with the aid of the report generating device 1 can be evaluated and a monitoring device 9 optionally can be informed on a cumulative occurrence of reported fault states in a suitably automated manner.

The reporting device 5 comprises a scanner 17 that is realized, for example, in the form of a camera 27. When a technician detects a fault state in a component 11 of the passenger transport system, the technician can read in machine-readable information 13 arranged on the component 11′, 11″, 11′″, e.g. in the form of a QR code 15, with the aid of this scanner 17. The machine-readable information 13 may comprise identity information that may contain, for example, information on the component type of the component being examined, its specific properties, a serial number, a usage site and/or other information.

The technician may additionally or alternatively also record fault information that makes it possible to draw conclusions on the fault state of the component 11′, 11″, 11′″ being examined. To this end, the technician can record an image of faulty parts 31′ among parts 31 of the component 11′, 11″, 11′″, e.g. with the camera 27 of the reporting device 5.

The identity information and/or fault information acquired by the reporting device 5 is then automatically transmitted to the analysis device 7 as component information in a first data transmission process 19. The analysis device 7 or the evaluating device 3 implemented thereby may be realized in the form of multiple computers that jointly form a data cloud. The analysis device 7 may alternatively be formed by a central computer. The analysis device 7 or the evaluating device 3 may respectively be linked to and receive information from a plurality of different reporting devices 5.

A list 33 of possible causes 37 of faults is stored in the analysis device 7. In this case, occurring problems (P) and possible causes 37 of faults that are causative for the occurring problems may be listed for each identity information (ID) 35, i.e. for each component type. Options for correcting the occurring problems could potentially also be included in the list 33. The frequency (H) 39, with which a possible cause of a fault occurs, is also recorded for each possible cause 37 of a fault in this case.

A selection of possible causes of faults is automatically selected based on the received component information, that includes the identity information and/or fault information, in the analysis device 7 by using the list 33 and then transmitted back to the reporting device 5 in the form of selection information in the course of a second data transmission process 21.

The selection information therefore represents a selection of possible causes of faults F1, F2, F3, F4, etc., which could be causative for the observed fault state. For example, the cause of the fault F1 may refer to the delivery of an incorrect component for the installation of a passenger transport system, the cause of the fault F2 may refer to a component having incorrect dimensions, the cause of the fault F3 may refer to the component having incorrect functional properties, etc. For example, the causes of the faults F1, F2, F3, F4 may be output on a display 25 of the reporting device 5 such that they can be easily perceived visually by a technician.

The reporting technician subsequently can select a sub-selection from the displayed selection information. For example, the technician may in this context select the cause of fault F1, F2, F3, F4, which in his opinion is actually or most likely causative for the presently observed fault state.

The corresponding sub-selection information is then automatically transmitted from the reporting device 5 to the analysis device 7 in the course of a third data transmission process 23.

In the course of time, the analysis device 7 or the evaluating device 3 therefore may respectively receive a plurality of reports from different reporting devices 5 and collect the possible causes of reported fault states cited in these reports.

The evaluating device 3 can correspondingly inform the monitoring device 9 as soon as the frequency 39, with which a certain possible cause 37 of a fault was reported to the evaluating device 3 specifically for a certain component type, exceeds a predefined frequency threshold value.

Developers can then attempt to enhance the corresponding component type in order to prevent the occurrence of the observed fault state in the future.

If such an attempt is successful, corresponding information can be transmitted to the analysis device 7, which then transmits this information onward to all reporting devices 5 that correspond with the analysis device or at least to the reporting devices 5 that have previously reported a corresponding fault state in the course of a fourth data transmission process 41.

All in all, the approach proposed herein can simplify the process of generating reports relating to fault states in components of a passenger transport system for a technician because the technician is to a large extend automatically supported by the report generating device 1. In addition, the reports can be generated in standardized form such that the evaluating device 3 can easily extract information, which allows a targeted enhancement of components 11′, 11″, 11′″, from these reports.

In conclusion, it should be noted that terms such as “having,” “comprising,” etc. do not preclude any other elements or steps and that terms such as “a” or “an” do not preclude a plurality. It should furthermore be noted that characteristics or steps, which were described above with reference to one of the exemplary embodiments, can also be used in combination with other characteristics or steps of other above-described exemplary embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

### LIST OF REFERENCE SYMBOLS

1 Report generating device
3 Evaluating device
5 Reporting device
7 Analysis device
9 Monitoring device
11′, 11″, 11′″ Components of passenger transport system
13 Machine-readable information
15 QR code
17 Scanner
19 First data transmission process
21 Second data transmission process
23 Third data transmission process
25 Display
27 Camera
31, 31′ Parts of a component
33 List of possible causes of faults
35 Identity information
37 Possible cause of a fault
39 Frequency
41 Fourth data transmission process

1-14. (canceled)

15. A method for reporting, in a machine-supported manner, fault states related to components of a passenger transport system, the method comprising the steps of:
selecting one of the components to be examined and operating a reporting device to acquire component information about the component being examined, the component information including at least one of identity information and fault information, wherein the identity information describes an identity of the component being examined, and wherein the fault information describes a fault state in the component being examined;
automatically transmitting the component information from the reporting device to an analysis device in a first data transmission process;
automatically selecting a selection of possible causes of a fault state of the component being examined from a list of possible causes of faults stored in the analysis device based on the component information and transmitting corresponding selection information that describes the selection of possible causes of the fault state to the reporting device in a second data transmission process;
automatically outputting the selection information to a display of the reporting device and receiving sub-selection information that describes a sub-selection possible cause selected by a reporter from the displayed selection information using the reporting device; and
automatically transmitting the sub-selection information from the reporting device to the analysis device in a third data transmission process.

16. The method according to claim 15 wherein the identity information is acquired by reading out machine-readable information stored on the component being examined.

17. The method according to claim 16 wherein the identity information is stored on the component being examined as an optically readable code and including reading out the code with a scanner integrated into the reporting device to acquire the identity information.

18. The method according to claim 15 including outputting the selection information to the reporting device in a language that can be preset by the reporter.

19. The method according to claim 15 including transmitting usage site information in the first transmission process, wherein the usage site information describes a usage site of the component being examined.

20. The method according to claim 15 including collecting the sub-selection information representing the possible causes of the fault state by performing the method steps multiple times, and automatically informing a monitoring device about the collected sub-section information related to any of the possible causes when a frequency of the related sub-section information exceeds a predefined frequency threshold value.

21. The method according to claim 20 including predefining the frequency threshold value with consideration of at least one of physical properties and functionalities of the component being examined.

22. The method according to claim 20 including predefining the frequency threshold value with consideration of a frequency of use of the component being examined.

23. The method according to claim 20 including collecting usage site information when the sub-selection information is collected, wherein the usage site information describes a usage site of the component being examined, and wherein the frequency threshold value is predefined with consideration of the usage site of the certain component type.

24. The method according to claim 20 including transmitting correction information from the analysis device to the reporting device as a proposal for correcting the fault state represented by the sub-selection information.

25. A report generating device for reporting fault states relating to components of a passenger transport system in a machine-supported manner, wherein the report generating device is adapted to carry out or control the method according to claim 15, the report generating device comprising: a reporting device with a display; and an analysis device in data communication with the reporting device.

26. A report generating device for reporting fault states relating to components of a passenger transport system in a machine-supported manner, wherein the report generating device is adapted to carry out or control the method according to claim 21, the report generating device comprising:
a reporting device with a display;
an evaluating device in data communication with the reporting device and including an analysis device that receives the component information and the sub-section information from the reporting device;
wherein the evaluating device evaluates the component information for the fault states relating to components of the passenger transport system in a machine-supported manner; and
wherein the evaluating device informs a monitoring device in a machine-supported manner of the fault states that have occurred in the components.

27. A computer program product comprising non-transitory machine-readable instructions that prompt a processor to carry out or to control the method according to claim 15.

28. A machine-readable medium with a computer program product according to claim 27 stored thereon.
